(19) United States
(12) Patent Application Publication
(10) Pub. No.: US 2024/0046449 A1
(43) Pub. Date: Feb. 8, 2024

(54) INSPECTION APPARATUS, INSPECTION METHOD, AND STORAGE MEDIUM

(71) Applicants: KABUSHIKI KAISHA TOSHIBA, Tokyo (JP); NuFlare Technology, Inc., Yokohama-shi Kanagawa (JP)

(72) Inventors: Takashi Watanabe, Yokohama Kanagawa (JP); Hiromu Inoue, Yokohama-shi (JP); Toshiyuki Ono, Kawasaki Kanagawa (JP)

(73) Assignees: KABUSHIKI KAISHA TOSHIBA, Tokyo (JP); NuFlare Technology, Inc., Yokohama-shi Kanagawa (JP)

(21) Appl. No.: 18/362,292

(22) Filed: Jul. 31, 2023

(30) Foreign Application Priority Data
Aug. 1, 2022 (JP) 2022-122623

(51) Int. Cl. G06T 7/00; G06T 5/30; G06T 5/50

(52) U.S. Cl. CPC G06T 7/001; G06T 5/30; G06T 5/50; G06T 2207/20224; G06T 2207/30148

(57) ABSTRACT

An inspection apparatus includes processing circuitry. The processing circuitry is configured to: acquire a first image and a second image for inspecting an inspection target; generate a plurality of deformed images by applying a plurality of deformation processes to at least one of the first image or the second image; calculate, for each pixel, a difference value between a pixel value of the first image and a pixel value of the second image, using the deformed images; calculate a pixel-by-pixel integrated difference value by integrating a plurality of difference values calculated for the respective deformed images; and detect an anomaly of the inspection target based on the pixel-by-pixel integrated difference value.

### CROSS-REFERENCE TO RELATED APPLICATION

This application is based upon and claims the benefit of priority from Japanese Patent Application No. 2022-122623, filed Aug. 1, 2022, the entire contents of which are incorporated herein by reference.

### FIELD

Embodiments described herein relate generally to an inspection apparatus, an inspection method, and a storage medium.

### BACKGROUND

To inspect an anomaly of a specimen, an apparatus configured to compare a plurality of images is used. Examples of the specimen to be inspected include a mask for manufacturing a semiconductor device. At the time of inspection, a pattern is formed on a wafer by exposing it through a mask in which a circuit pattern is formed on a material such as glass. Thus, anomalies such as pattern defects present in the mask and foreign matter adhering to the mask may lead to a decrease in the yield.

As a method of inspecting mask pattern defects, a die-and-die comparison inspection and a die-and-database comparison inspection, for example, are known. In a die-and-die comparison inspection, images of two dies on a reticle, namely, a reference image of a die to be a reference and an inspection image of a die to be an inspection target, are compared. In a die-and-database comparison inspection, a reference image generated from CAD data showing a design pattern and an inspection image of a die to be an inspection target are compared. As a method of inspecting defects and foreign matter, an inspection method of comparing images of a die to be an inspection target captured in different methods, for example, is known. Representative examples of such an inspection method include a method of comparing a transmission image generated with light that has transmitted through a specimen and a reflection image generated with light reflected from the specimen.

In recent years, with the reduction in size of semiconductor devices, the optical magnification at the time of imaging of an inspection target has been increasing. In accordance therewith, the effect of, for example, a position gap between comparison targets increases, causing a difference in inspection images even in a normal region not including a defect or foreign matter that should be detected, causing the problem of error detection.

For example, an inspection method is known in which a parameter for correcting a position gap between a reference image and an inspection image is calculated by simultaneous equations, a correction image is generated by correcting the position of the reference image using the parameter, and making a comparison between the correction image and the inspection image. However, in such a method in which a position gap is correctly calculated from actual images and the gap is corrected, processing such as solving simultaneous equations, which is complicated, and retaining a large number of items of correction information for each pattern shape is required. Moreover, with the improvement in optical magnification, in order to correct pattern fluctuations not resulting from defects and/or uneven displacements between images resulting from optical characteristics, as well as a simple position gap, further complicated processing will be required.

### BRIEF DESCRIPTION OF THE DRAWINGS

FIG. 1 is a conceptual diagram showing a configuration example of an inspection apparatus according to an embodiment.

FIG. 2 is a diagram for illustrating general characteristics of a transmission image and a reflection image.

FIG. 3 is a diagram for illustrating an example of a general method of detecting an anomaly using a transmission image and a reflection image.

FIG. 4 is a flowchart showing an operation example of an inspection apparatus according to an embodiment.

FIG. 5 is a diagram showing an example of processing of generating a plurality of deformed images from a transmission image.

FIG. 6 shows an example of processing of generating a difference image using a deformed image of a transmission image and a reflection image.

FIG. 7 is a diagram showing an example of a pixel value of each deformed image of a transmission image and a pixel value of an inverted reflection image.

FIG. 8 is a diagram illustrating example processing of integrating a plurality of difference values.

FIG. 9 is a diagram showing an example of an integrated difference value calculated by edge detection processing.

FIG. 10 is a diagram illustrating deformation processing by an inspection apparatus according to a first modification.

FIG. 11 is a conceptual diagram showing an inspection apparatus according to a second modification.

FIG. 12 is a flowchart showing an operation example of an inspection apparatus according to a second modification.

FIG. 13 is a diagram showing an example of a pixel value of each of a plurality of deformed images of a reflection image and a pixel value of a transmission image according to the second modification.

FIG. 14 is a diagram illustrating example processing of integrating a plurality of difference values according to the second modification.

FIG. 15 is a conceptual diagram showing an inspection apparatus according to a third modification.

FIG. 16 is a flowchart showing an operation example of an inspection apparatus according to a third modification.

FIG. 17 is a diagram illustrating example processing of integrating a plurality of difference values according to a third modification.

FIG. 18 is a diagram showing a hardware configuration of an inspection apparatus according to a fourth modification.

### DETAILED DESCRIPTION

In general, according to one embodiment, an inspection apparatus includes processing circuitry. The processing circuitry is configured to: acquire a first image and a second image for inspecting an inspection target; generate a plurality of deformed images by applying a plurality of deformation processes to at least one of the first image or the second image; calculate, for each pixel, a difference value between a pixel value of the first image and a pixel value of the second image, using the deformed images; calculate a pixel-by-pixel integrated difference value by integrating a plurality of difference values calculated for the respective deformed images; and detect an anomaly of the inspection target based on the pixel-by-pixel integrated difference value.

Hereinafter, an inspection apparatus, an inspection method, and a program according to an embodiment will be described in detail with reference to the drawings. In the following description, constituent elements having substantially the same function and configuration will be assigned a common reference symbol, and redundant descriptions will be given only where necessary.

<Description of Apparatus>

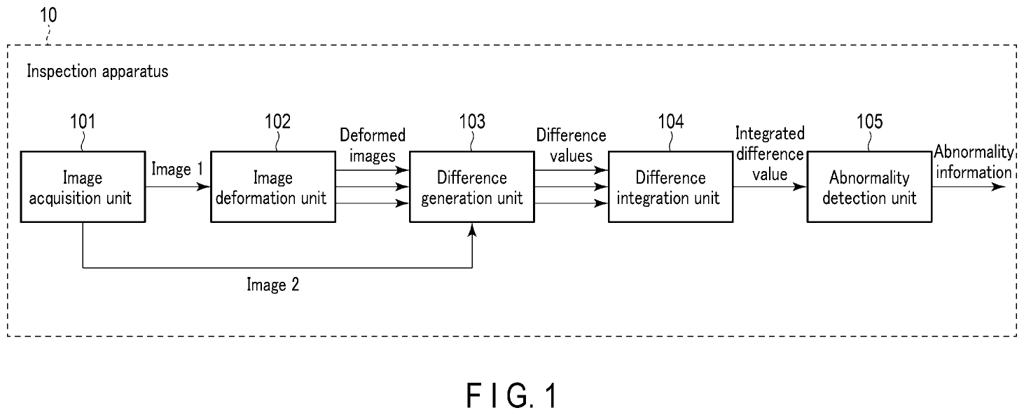

FIG. 1 is a conceptual diagram showing a configuration example of an inspection apparatus 10 to which an inspection method according to an embodiment is applied. The inspection apparatus 10 is an apparatus configured to inspect a mask for manufacturing a semiconductor device for anomalies. Examples of the anomalies of a mask include defects present in the mask and foreign matter adhering to the mask. In the present embodiment, a case will be mainly explained where foreign matter adhering to a mask is detected.

The inspection apparatus 10, as shown in FIG. 1, includes processing circuitry configured to control the entire inspection apparatus 10 and a storage medium (memory). The processing circuitry is a processor configured to call and execute programs in the storage medium, thereby executing functions of an image acquisition unit 101, an image deformation unit 102, a difference generation unit 103, a difference integration unit 104, and an anomaly detection unit 105. The processing circuitry is formed of an integrated circuit including a central processing unit (CPU), an application-specific integrated circuit (ASIC), a field-programmable gate array (FPGA), etc. The processor may be formed either of a single integrated circuit or a plurality of integrated circuits.

It is to be noted that the image acquisition unit 101, the image deformation unit 102, the difference generation unit 103, the difference integration unit 104, and the anomaly detection unit 105 may be either realized by software executed by a processor such as a CPU or realized by dedicated hardware. That is, the functions of the image acquisition unit 101, the image deformation unit 102, the difference generation unit 103, the difference integration unit 104, and the anomaly detection unit 105 may be either realized by a single processing circuit, or realized by a combination of independent processors configuring processing circuitry and executing the respective programs. Also, the functions of the image acquisition unit 101, the image deformation unit 102, the difference generation unit 103, the difference integration unit 104, and the anomaly detection unit 105 may be implemented as individual hardware circuits.

The storage medium stores processing programs used in the processor, as well as parameters, tables, etc. used in computation at the processor. The storage medium is a storage device such as a hard disk drive (HDD), a solid-state drive (SSD), and an integrated circuit configured to store various types of information. The storage device may be a portable storage medium such as a compact disc (CD), a Digital Versatile Disc (DVD), and a flash memory, as well as an HDD, an SSD, etc., and may be a drive device configured to read and write various types of information from and to a semiconductor memory device, etc. such as a flash memory and a random-access memory (RAM).

The image acquisition unit 101 acquires an image 1 and an image 2 for inspecting an inspection target. The image 1 corresponds to a first image. The image 2 corresponds to a second image. The image acquisition unit 101 outputs the image 1 to the image deformation unit 102, and outputs the image 2 to the difference generation unit 103. The images 1 and 2 may be stored in advance in the memory of the inspection apparatus 10, or may be acquired from an external device or a database connected to the inspection apparatus 10 in a wired or wireless manner.

The images 1 and 2 are two types of images used to inspect a mask for anomalies. In the case of, for example, detecting foreign matter adhering to a mask, a transmission image generated based on light that has transmitted through the mask to be inspected and a reflection image generated based on light reflected from the mask to be inspected are used as the images 1 and 2. For example, if the image 1 is a transmission image, the image 2 is a reflection image, and if the image 1 is a reflection image, the image 2 is a transmission image.

In the case of the inspection apparatus 10 being an inspection apparatus configured to detect a defect of a mask, a mask image to be a reference (hereinafter referred to as a “reference image”) and a mask image to be inspected (hereinafter referred to as an “inspection image”) are respectively used as the images 1 and 2. For example, if the image 1 is a reference image, the image 2 is an inspection image, and if the image 1 is an inspection image, the image 2 is a reference image. The reference image is, for example, an image generated from CAD data showing a design pattern of a mask, or an image generated by photographing a normal mask.

The image deformation unit 102 generates a plurality of deformed images by applying a plurality of deformation processes on at least one of the images 1 and 2. In the present embodiment, the image deformation unit 102 generates a plurality of deformed images by performing a plurality of different deformation processes on the image 1 output from the image acquisition unit 101. Thereafter, the image deformation unit 102 outputs the generated deformed images to the difference generation unit 103.

In the case of using a transmission image and a reflection image as the images 1 and 2, dilation processing or erosion processing, for example, is used as the deformation processing. The dilation processing refers to processing of replacing a pixel value of each pixel with a largest pixel value of its neighboring pixels. The erosion processing refers to processing of replacing a pixel value of each pixel with a smallest pixel value of its neighboring pixels. In the case of using, for example, dilation processing as the deformation processing, a plurality of dilation processes in which different ranges of neighboring pixels are referred to are used as the plurality of different deformation processes. In the case of using erosion processing as the deformation processing, a plurality of erosion processes in which different ranges of neighboring pixels are referred to are used as the plurality of different deformation processes.

The difference generation unit 103 calculates, for each pixel, a difference value (hereinafter also referred to as a “pixel value difference”) between a pixel value of the image 1 and a pixel value of the image 2, using the plurality of deformed images. In the present embodiment, the difference generation unit 103 acquires the plurality of deformed images output from the image deformation unit 102 and the image 2 output from the image acquisition unit 101, and calculates, for each pixel, a difference value between a pixel value of each of the deformed images and a pixel value of the image 2. Thereafter, the difference generation unit 103 outputs a plurality of difference values obtained for each deformed image to the difference integration unit 104.

A transmission image and a reflection image are light-dark inverted. Accordingly, in the case of using a transmission image and a reflection image as the images 1 and 2, to calculate a difference value, the difference generation unit 103 generates an inverted image by applying inversion processing of performing light-dark inversion on one of the transmission image and the reflection image, and calculates the difference value using the inverted image to which the inversion processing has been applied and a normal image, which is one of the transmission image and the reflection image to which inversion processing is not applied.

Also, to calculate a difference value, the difference generation unit 103 subjects the inverted image or the normal image to a pixel value correction so that a range of pixel values of the inverted image and a range of pixel values of the normal image match each other, and calculates the difference value using the image subjected to the pixel value correction. By thus calculating a difference value after adjusting pixel values of two images between which the difference value is calculated, a difference value in a normal region in which an anomaly is not present can be kept small.

The difference integration unit 104 integrates difference values output from the difference generation unit 103, and obtains a final difference value. In other words, the difference integration unit 104 generates a single difference value by merging a plurality of difference values. Specifically, the difference integration unit 104 calculates, for each pixel, a difference value (hereinafter referred to as an “integrated difference value”) obtained by integrating a plurality of difference values calculated for each of the deformed images. For example, for each pixel, a difference value whose absolute value is smallest is selected from among a plurality of difference values, and an integrated difference value is calculated as the absolute value of the selected difference value. By thus calculating the integrated difference value, a difference between the pixel value of the image 1 and the pixel value of the image 2 resulting from a small displacement in pattern can be kept small. It is to be noted that the difference values may be integrated by any other method. The difference integration unit 104 outputs the calculated integrated difference value to the anomaly detection unit 105.

The anomaly detection unit 105 detects an anomaly of an inspection target based on the integrated difference value. Specifically, the anomaly detection unit 105 performs, for each pixel, normal/anomalous determination based on the integrated difference value output from the difference integration unit 104. If there are any anomalies such as adhesion of foreign matter or existence of a defect, the integrated difference value of a pixel in a region to which the foreign matter adheres or a region in which the defect exists becomes large. Accordingly, by performing, for example, threshold processing on the integrated difference value, it is possible to perform determination as to whether each pixel is normal or anomalous. The threshold value is set in advance and is stored in, for example, the memory of the inspection apparatus 10. It is to be noted that the anomaly detection may be performed by any other method using the integrated difference value. The anomaly detection unit 105 outputs anomaly information containing an anomaly detection result to an external device, etc.

As described above, in processing of the difference integration unit 104, by selecting a difference value whose absolute value is smallest from among a plurality of difference values, a difference between the pixel values resulting from a small displacement in pattern can be kept small. It is thereby possible to detect only differences between the pixel values resulting from anomalies of the mask, resulting in improvement in anomaly detection properties. That is, since the effect of a small pattern displacement between the images 1 and 2 is suppressed by the processing of the difference integration unit 104, the integrated difference value becomes small in a normal region in which an anomaly is not present. Accordingly, in the processing of the anomaly detection unit 105, it is possible to correctly detect an anomaly by determining only a pixel with a difference value equal to or higher than a threshold value to be anomalous.

<Description of Operation>

Next, an operation of processing executed by the inspection apparatus 10 will be described. Herein, processing of detecting foreign matter adhering to a mask using a transmission image and a reflection image will be described as an example of anomaly detection processing. Also, a case will be described where the image 1 is a transmission image and the image 2 is a reflection image.

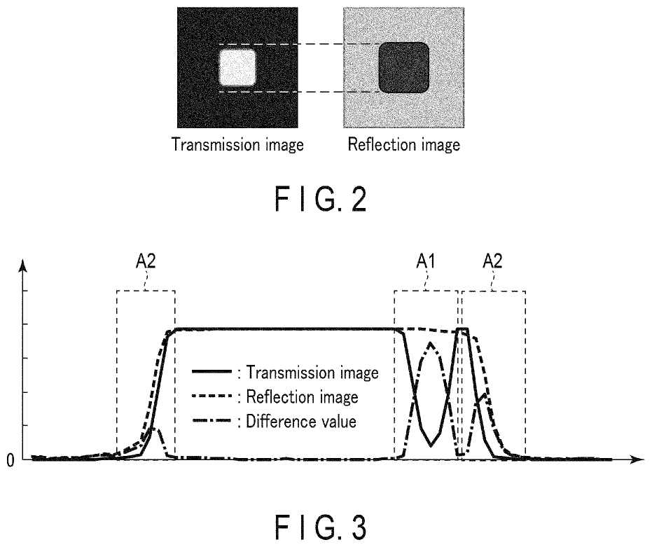

General characteristics of a transmission image and a reflection image will be described with reference to FIGS. 2 and 3. FIG. 2 is a conceptual diagram showing general characteristics of a transmission image and a reflection image. FIG. 2 shows an example in which a transmission image and a reflection image are generated by imaging an identical specimen at an identical position. In general, a transmission image and a reflection image are captured using light that has transmitted through a specimen and light that has been reflected from the specimen, respectively, and therefore have light-dark inverted properties, as shown in FIG. 2. FIG. 3 is a diagram for illustrating a general relationship among a pixel value of a transmission image, a pixel value of a reflection image, and a difference value between the pixel value of the transmission image and the pixel value of the reflection image. In FIG. 3, the reflection image is shown in a light-dark inverted state.

FIG. 3 shows an example in which the pixel value of the transmission image has decreased in a region A1 due to the effect of foreign matter. Since only the pixel value of the transmission image decreases due to the presence of an anomaly in the region A, the difference value between the transmission image and the reflection image increases, thus allowing the anomaly to be detected.

In general, a displacement resulting from optical characteristics occurs at the pattern edge between a transmission image and a reflection image. Accordingly, a pattern of a light portion in the transmission image is photographed in a small size compared to a pattern of a dark portion in the reflection image, as shown in FIG. 2. The higher the optical magnification under which the transmission image and the reflection image are captured, the greater the effect produced by the displacement at the pattern edge on inspection. With the increase in the displacement at the pattern edge, even if an anomaly is not present, a large difference value may occur in a peripheral region A2 of the pattern edge, as shown in FIG. 3, thus causing erroneous anomaly detection.

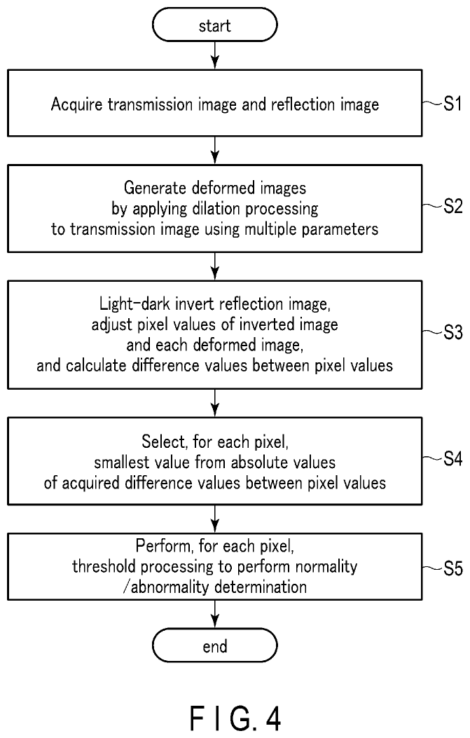

FIG. 4 is a flowchart showing an example of procedures for anomaly detection processing executed by the inspection apparatus 10. It is to be noted that the procedures in the processing to be described below are given merely as an example, and may be suitably varied wherever possible. In the procedures to be described below, omission, substitution, and addition of one or more steps may be performed according to the embodiment.

(Step S1)

At step S1, the image acquisition unit 101 acquires a transmission image and a reflection image. The transmission image and the reflection image are acquired by, for example, actually capturing the images. In this case, an inspection target specimen is actually irradiated with light such as visible light, ultraviolet light, etc., and transmitted light, which has transmitted through a specimen, and reflected light, which has reflected from the specimen, are received by a sensor, thereby generating the transmission image and the reflection image based on a result of the reception. Alternatively, the transmission image and the reflection image may be acquired by reading, from a storage medium such as a memory, a transmission image and a reflection image captured in advance. After acquiring the transmission image and the reflection image, the image acquisition unit 101 outputs the transmission image to the image deformation unit 102, and outputs the reflection image to the difference generation unit 103.

(Step S2)

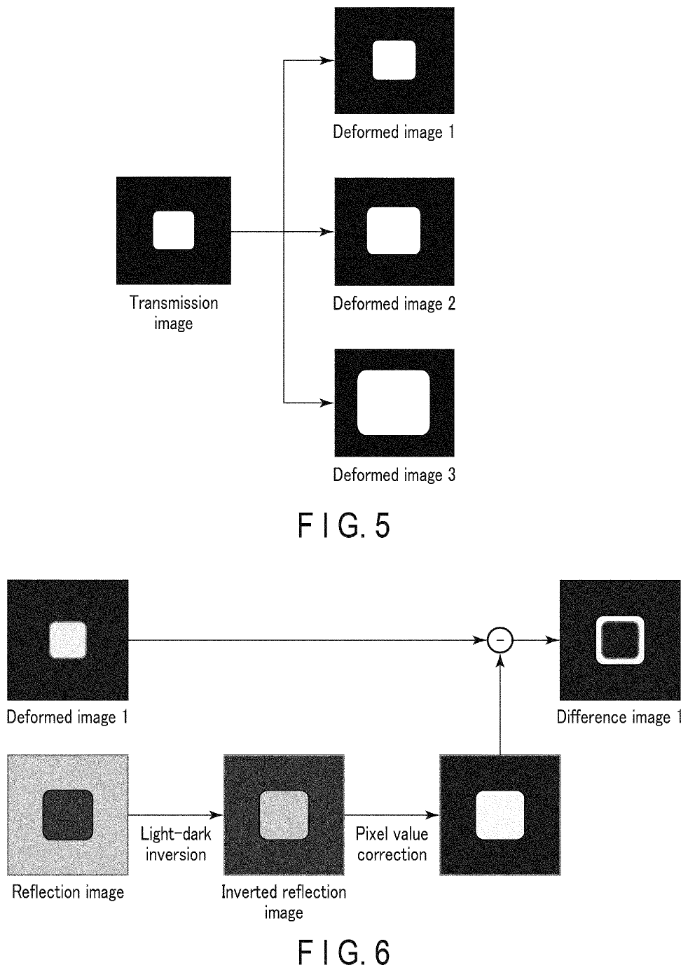

At step S2, the image deformation unit 102 applies deformation processing to the transmission image output from the image acquisition unit 101. Since the light-portion pattern in the transmission image is photographed in a smaller size compared to the dark-portion pattern of the reflection image at an identical region, as described above, the size of the light-portion pattern of the transmission image can be made closer to that of the dark-portion pattern of the reflection image by applying dilation processing to the transmission image. FIG. 5 is a diagram showing an example of processing of generating a plurality of deformed images from a transmission image. As shown in FIG. 5, in the present embodiment, the image deformation unit 102 applies three types of dilation processes in which different ranges are referred to a transmission image, and generates, as the deformed images, a 0-pixel dilated image (deformed image 1) obtained by referring to zero neighboring pixels and replacing the pixel value of each pixel with the largest pixel value thereamong, a 1-pixel dilated image (deformed image 2) obtained by referring to one neighboring pixel and replacing the pixel value of each pixel with the largest pixel value thereamong, and a 2-pixel dilated image (deformed image 3) obtained by referring to two neighboring pixels and replacing the pixel value of each pixel with the largest pixel value thereamong. The 0-pixel dilated image is the same as the original transmission image. The 1-pixel dilated image is an image in which a light portion of the original transmission image is dilated by one pixel. The 2-pixel dilated image is an image in which the light portion of the original transmission image is dilated by two pixels. The image deformation unit 102 outputs the generated three types of deformed images to the difference generation unit 103.

In the present embodiment, an example has been described in which three types of dilation images are generated as a plurality of deformed images; however, the number of deformed images that are generated may be freely set according to the properties of the image of the inspection target. For example, two types of deformed images may be generated by dilation processes in which different numbers of neighboring pixels are referred to; furthermore, four or more types of deformed images may be generated. Also, the number of pixels by which the dilation is performed may be set according to the number of pixels by which the pattern edge is displaced between the transmission image and the reflection image. For example, the number of pixels by which the pattern edge is displaced may be studied in advance, and dilation processing of dilating the light-portion pattern by that number may be applied.

(Step S3)

At step S3, the difference generation unit 103 calculates a difference value between a pixel value of a reflection image output from the image acquisition unit 101 and a pixel value of each of the deformed images output from the image deformation unit 102. The difference value is a difference between the pixel values (brightness values). In the present embodiment, since three types of dilation images are output by the image deformation unit 102, the difference generation unit 103 calculates, for each pixel, three difference values, namely, a difference value between the pixel value of the 0-pixel dilated image and the pixel value of the reflection image, a difference value between the pixel value of the 1-pixel dilated image and the pixel value of the reflection image, and a difference value between the pixel value of the 2-pixel dilated image and the reflection image.

Herein, a method of calculating the difference value will be described in detail with reference to FIG. 6. FIG. 6 shows an example of processing of generating a difference image using a deformed image of a transmission image and a reflection image. As described above, the transmission image and the reflection image are light-dark reversed. Accordingly, to calculate a difference value between the transmission image and the reflection image, either the transmission image or the reflection image needs to be light-dark inverted. In the present embodiment, the difference generation unit 103 generates an inverted reflection image by light-dark inverting the reflection image. The light-dark inversion is realized by, for example, subtracting a pixel value of each pixel from a theoretical largest pixel value. That is, in the case of an 8-bit image, the pixel values can be inverted by subtracting a pixel value of each pixel from 255, which is the largest pixel value.

The pixel values of the light and dark portions may differ between the deformed image and the inverted reflection image. Accordingly, the difference generation unit 103 performs correction processing of correcting pixel values of one or both of the deformed image and the inverted reflection image to make the ranges of the pixel values (pixel value ranges) of the deformed image and the inverted reflection image match. By calculating difference values using the corrected images, a difference value in the normal region can be kept small.

Herein, a case will be described, as an example, where a pixel value R (x, y) at a pixel position (x, y) of the inverted reflection image is corrected by Formula (1).

$${R}^{′} ( x , y ) = ( R ( x , y ) - {R}_{D} ) \frac{{T}_{L} - {T}_{D}}{{R}_{L} - {R}_{D}} + {T}_{D} \qquad ( 1 )$$

The R_{L}, R_{D}, T_{L}, and T_{D} in Formula (1) respectively denote a representative pixel value of a light portion of the inverted reflection image, a representative pixel value of a dark portion of the inverted reflection image, a representative pixel value of a light portion of the deformed image, and a representative pixel value of a dark portion of the deformed image. Representative values may be determined in advance using results of calibration at the time of imaging, or may be directly calculated from images. In the case of directly calculating representative values from images, an average or central value of pixel values in a partial region of a light or dark portion, or a peak pixel value in a histogram of pixel values, for example, may be used as a representative value. By applying the linear formation of Formula (1) to the inverted reflection image, the pixel values of the light/dark portions of the inverted reflection image and the deformed image are made to match. Accordingly, by performing correction processing, it is possible to suppress differences other than a difference resulting from a pattern displacement between the transmission image and the reflection image. In the example of FIG. 6, for example, in the difference image 1 generated based on the difference value calculated using the deformed image 1 and the inverted reflection image subjected to the pixel value correction, a region in the periphery of the pattern edge becomes a light portion because of the difference values resulting from a pattern displacement between the transmission image and the reflection image being large, and the other region becomes a dark portion because of the difference values being small as a result of the correction processing.

A case has been described, as an example, where a reflection image is light-dark inverted through inversion processing, and the inverted reflection image is pixel-value corrected through correction processing, thereby correcting pixel values of the inverted reflection image in accordance with those of the deformed image; however, such processing may be performed on a deformed image of a transmission image. For example, a deformed image may be light-dark inverted by applying inversion processing to the deformed image. Moreover, pixel values of an inverted deformed image may be corrected in accordance with those of a reflection image. Furthermore, one of inversion processing and correction processing may be applied to a deformed image, and the other processing may be applied to a reflection image.

Moreover, inversion processing may be executed on a transmission image prior to generation of a deformed image of a transmission image. In this case, erosion processing is applied, instead of dilation processing, as deformation processing to an inverted transmission image obtained by inverting a transmission image. Thereby, an image similar to the image obtained by performing inversion processing on an dilation image of a transmission image can be generated.

(Step S4)

At step S4, the difference integration unit 104 calculates an integrated difference value by integrating a plurality of difference values output from the difference generation unit 103. The integrated difference value is a final difference value. The difference integration unit 104 outputs the calculated integrated difference value to the anomaly detection unit 105. Example methods of integrating the difference values include a method of comparing absolute values of the difference values calculated for each deformed image, and selecting the smallest value as the final integrated difference value. With such a method, it is possible to suppress a difference value resulting from a pattern displacement.

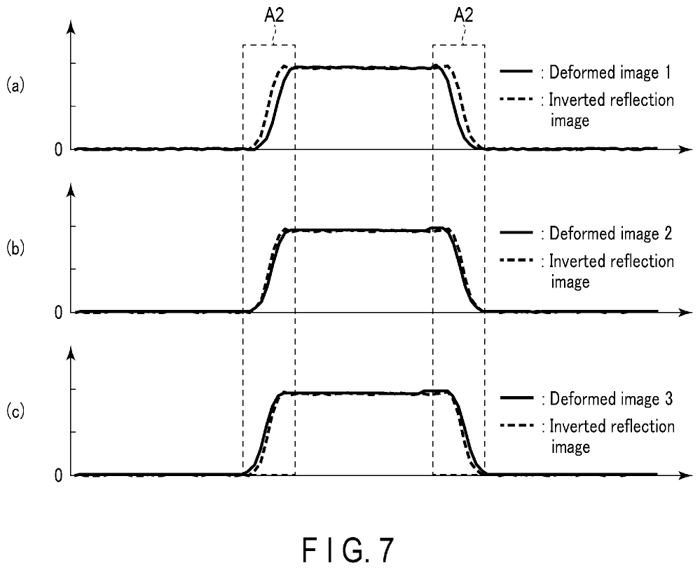

Processing of calculating difference values and processing of integrating the difference values will be described in detail with reference to FIGS. 7 to 9. FIG. 7 is a diagram showing a pixel value of each of a plurality of deformed images and a pixel value of an inverted reflection image. The pixel values shown in FIG. 7 are of pixels on a single pixel line at the center of each image. The horizontal axis in FIG. 7 denotes a position on the single pixel line. The vertical axis in FIG. 7 denotes a pixel value. FIG. 7(a) shows a pixel value of the deformed image 1 (0-pixel dilated image) and a pixel value of the inverted reflection image, FIG. 7(b) shows a pixel value of the deformed image 2 (1-pixel dilated image) and a pixel value of the inverted reflection image, and FIG. 7(c) shows a pixel value of the deformed image 3 (2-pixel dilated image) and a pixel value of the inverted reflection image. In FIG. 7, the solid lines represent the pixel values of the deformed images, and the dashed lines represent the pixel values of the inverted reflection image.

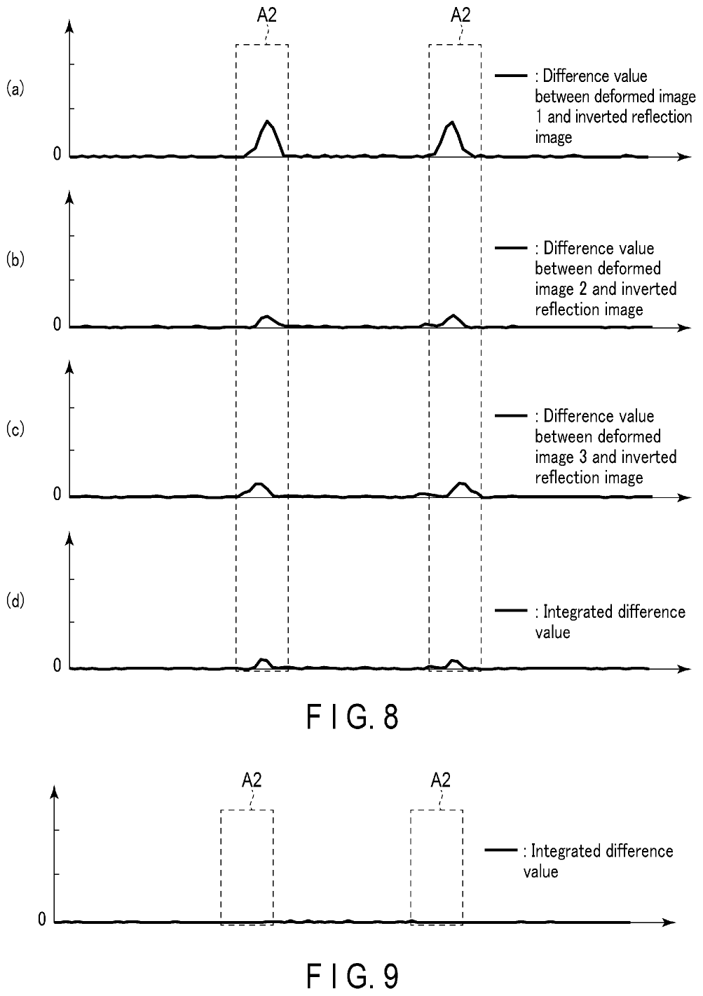

FIG. 8 is a diagram illustrating example processing of integrating a plurality of difference values. The horizontal axis in FIG. 8 denotes a position on the same pixel line as that in FIG. 7. The vertical axis in each of FIGS. 8(a)-(c) denotes an absolute value of a difference value between each of a plurality of deformed images and an inverted reflection image. FIG. 8(a) denotes an absolute value of a difference value between the deformed image 1 (0-pixel dilated image) and the inverted reflection image, FIG. 8(b) denotes an absolute value of a difference value between the deformed image 2 (1-pixel dilated image) and the inverted reflection image, and FIG. 8(c) denotes an absolute value of a difference value between the deformed image 3 (2-pixel dilated image) and the inverted reflection image.

It can be seen that, since the pattern width of the light portion of the transmission image is smaller than that of the inverted reflection image, the difference value between the deformed image 1 (0-pixel dilated image), which is the same as the transmission image, and the inverted reflection image is large in the peripheral region A2 of the pattern edge, as shown in FIGS. 7 and 8. On the other hand, in the deformed image 2 (1-pixel dilated image), since the pattern width of the light portion of the transmission image is increased, the position of the pattern edge in the peripheral region A2 of the pattern edge is close to the position of the pattern edge of the inverted reflection image, compared to the deformed image 1. Thus, the difference value between the deformed image 2 and the inverted reflection image is small in the peripheral region A2 of the pattern edge. In the deformed image 3 (2-pixel dilated image), since the pattern width of the light portion of the transmission image is greater than that of the inverted reflection image and the position of the pattern edge has moved to the outside, a positional relationship at the pattern edge between the deformed image 3 and the inverted reflection image is reversed in the peripheral region A2 of the pattern edge. Thus, the position at which the difference value between the deformed image 3 and the inverted reflection image increases becomes different. In the deformed image 3, too, since the position of the pattern edge is close to the position of the pattern edge of the inverted reflection image, compared to the deformed image 1, the difference value between the deformed image 3 and the inverted reflection image in the peripheral region of the pattern edge decreases.

FIG. 8(d) is a diagram showing an integrated difference value. In FIG. 8(d), the vertical axis denotes an integrated difference value. As the integrated difference value, the smallest value is selected for each pixel from among a plurality of difference values. Accordingly, it can be seen that the integrated difference value is kept small by selecting, in the peripheral region A2 of the pattern edge, for example, either a difference value between the deformed image 2 (1-pixel dilated image) and the inverted reflection image or a difference value between the deformed image 3 (2-pixel dilated image) and the inverted reflection image.

Also, in the present embodiment, processing (hereinafter referred to as “edge specification processing”) of specifying a position of a pattern edge and making an integrated difference value at the specified position zero may be executed to further suppress the difference values at the pattern edge. The edge specification processing may not be executed. FIG. 9 is a diagram showing an integrated difference value in the case where edge specification processing is applied to the integrated difference value in FIG. 8(d). The horizontal axis in FIG. 9 denotes a position on the same single pixel line as that in FIG. 7. In FIG. 9, the vertical axis denotes an integrated difference value. As the degree of deformation in the deformation processing increases with the increase in the dilation number in the dilation processing, the positional relationship of the pattern edge between the deformed image and the inverted reflection image is reversed, as shown in FIGS. 7(b) and 7(c). In the periphery of the pattern edge, for example, the pixel values of the deformed image 1 and the deformed image 2 are greater than the pixel value of the inverted reflection image, as shown in FIGS. 7(a) and 7(b), but the pixel value of the deformed image 3 is smaller than the pixel value of the inverted reflection image, as shown in FIG. 7(c). Accordingly, by specifying a pixel at which the magnitude relationship between the pixel value of each deformed image and the pixel value of the inverted reflection image is reversed, it is possible to specify the position of the pattern edge in the inverted reflection image. For example, if a pixel value of a pixel of the deformed image 1 is smaller than a pixel value of the same pixel of the inverted reflection image, and a pixel value of the same pixel of the deformed image 3 is greater than a pixel value of the same pixel of the inverted reflection image, the pixel in the inverted reflection image can be estimated to be located at the pattern edge. By replacing the integrated difference value of the pixel estimated to be located at the pattern edge with 0, it is possible to further suppress an increase of a difference value in the periphery of the pattern edge due to the effect of a pattern displacement, as shown in FIG. 9.

However, in the case where edge specification processing is applied, a small anomaly, if any, present in the periphery of the pattern edge may not be detected. Accordingly, it is preferable that a change be made as to whether edge specification processing is applied according to the characteristics of an anomaly to be detected.

(Step S5)

At step S5, the anomaly detection unit 105 performs threshold processing on the integrated difference value output from the difference integration unit 104, and performs determination as to whether the inspection target is normal or anomalous. As described above, with the processing at steps S1-S4, a difference value that has occurred by a cause other than an anomaly such as foreign matter or a defect is suppressed. Accordingly, the integrated difference value becomes large only at a pixel at which an anomaly is present. Thus, by specifying the pixel at which the integrated difference value is large by the threshold processing, the presence of the anomaly can be detected. The threshold value may be a value set in advance, or may be relatively (dynamically) set using a histogram, etc. of the integrated difference values of the entire image.

In FIGS. 7 to 9, a method of calculating an integrated difference value on a specific single pixel line at the center of an image has been described; however, in actual processing, such an approach is applied to the entire image, thereby calculating an integrated difference value of each pixel of the entire image, and performing anomaly determination using the integrated difference values of the entire image.

If an anomaly is detected at a plurality of continuous pixels, further determination may be performed, depending on the size and shape of the area including the plurality of continuous pixels, as to the type of the anomaly, whether or not the detection of the anomaly is erroneous, etc.

(Effects)

The effects of the inspection apparatus 10 according to the present embodiment will be described.

As described above, as the position gap at the pattern edge between the transmission image and the reflection image increases with the increase in optical magnification at the time of imaging of an inspection target, the difference value (pixel value difference) between the pixel values increases even in a normal region in which an anomaly such as foreign matter or a defect is not present, possibly causing erroneous anomaly detection.

The inspection apparatus 10 according to the present embodiment includes an image acquisition unit 101, an image deformation unit 102, a difference generation unit 103, a difference integration unit 104, and an anomaly detection unit 105. The image acquisition unit 101 acquires a transmission image and a reflection image. The image deformation unit 102 generates a plurality of deformed images (a 0-pixel dilated image, a 1-pixel dilated image, and a 2-pixel dilated image) by applying a plurality of dilation processes with different dilation numbers to the transmission image. The difference generation unit 103 calculates, for each pixel, a difference value between the pixel value of the transmission image and the pixel value of the reflection image using the plurality of deformed images. At this time, the difference generation unit 103 generates an inverted image (inverted reflection image) by applying inversion processing of light-dark inverting the reflection image, and calculating a difference value using a normal image (a deformed image of a transmission image) to which inversion processing is not applied and an inverted image (inverted reflection image). The difference integration unit 104 calculates, for each pixel, an integrated difference value obtained by integrating a plurality of difference values calculated for each of the deformed images. For example, for each pixel, the difference integration unit 104 selects, as the integrated difference value, a difference value whose absolute value is smallest from a plurality of difference values. The anomaly detection unit 105 detects foreign matter adhering to a mask based on the integrated difference value.

With the above-described configuration of the inspection apparatus 10 according to the present embodiment, since the position of the pattern edge is close to the pattern edge of the inverted reflection image in the dilation image of the transmission image, a difference value resulting from a position gap at the pattern edge can be made small by calculating the difference value using the dilation image and the inverted reflection image. Also, by integrating a difference value using a plurality of deformed images, it is possible to select, for each pixel, an optimum difference value without the need to strictly correct a position gap. Thereby, the effect of occurrence of a difference resulting from the position gap at the pattern edge is suppressed, and only foreign matter adhering to the mask has a large effect on the integrated difference value. Accordingly, by performing anomaly detection using the integrated difference value, it is possible to suppress erroneous detection at the time of detection of foreign matter, and to improve the detection precision of foreign matter.

It suffices that the deformation processing is applied to at least one of a transmission image and a reflection image. For the deformation processing, either dilation processing or erosion processing is applied, according to the image to be applied and the order of other processes, etc. In the present embodiment, a case has been described where dilation processing is applied only to a transmission image and deformation processing is not applied to a reflection image; however, deformation processing may be applied only to the reflection image, or applied to both the transmission image and the reflection image.

For example, if only deformed images of a transmission image are generated, as in the present embodiment, the difference generation unit 103 calculates, as a difference value, a difference between the pixel value of each of the deformed images and the pixel value of the inverted image. If only deformed images of an inverted image are generated, the difference generation unit 103 calculates, as a difference value, a difference between the pixel value of each of the deformed images and the pixel value of the transmission image. If both deformed images of a transmission image and deformed images of an inverted image are generated, the difference generation unit 103 calculates, as a difference value, a difference between the pixel value of each of the deformed images of the transmission image and the pixel value of each of the deformed images of the inverted image.

It suffices that the inversion processing is applied to one of a transmission image and a reflection image. In the present embodiment, a case has been described where inversion processing is applied to a reflection image; however, inversion processing may be applied to a transmission image. Also, both inversion processing and deformation processing may be applied to either a transmission image or a reflection image; in this case, the deformation processing may be applied after application of the inversion processing, or the inversion processing may be applied after application of the deformation processing.

As described in the present embodiment, in the case where deformation processing is to be applied to a transmission image and inversion processing is to be applied to a reflection image, dilation processing is used as the deformation processing. In the case where deformation processing is to be applied to a reflection image and inversion processing is to be applied to a transmission image, dilation processing is used as the deformation processing. In the case of applying both deformation processing and inversion processing to either a transmission image or a reflection image, the inversion processing is performed after performing dilation processing, or erosion processing is performed after performing inversion processing.

In the present embodiment, to calculate a difference value, the difference generation unit 103 subjects an inverted image or a normal image to pixel value correction so that a range of pixel values of the inverted image and a range of pixel values of the normal image match each other, and calculates the difference value using the image subjected to the pixel value correction. By thus adjusting pixel values of two images based on which difference values are to be calculated and then calculating the difference values, a difference value in a normal region in which an anomaly is not present can be kept small.

In the present embodiment, edge specification processing of specifying a position of a pattern edge and making an integrated difference value at the specified position zero may be executed. At this time, the difference integration unit 104 sets an integrated difference value of a pixel, for which the calculated difference values have different signs, to zero. By specifying a pixel at which the magnitude relationship between the pixel value of each deformed image and the pixel value of the normal image is reversed, utilizing the characteristic whereby the positional relationship at the pattern edge between the deformed image and the normal image to which deformation processing is not applied is reversed in accordance with an increase in the degree of deformation in the deformation processing, it is possible to specify the position of the pattern edge. By replacing an integrated difference value at the pixel estimated to be located at the pattern edge with zero, it is possible to suppress an increase of the difference value due to the effect of a pattern displacement in the periphery of the pattern edge.

(First Modification)

A first modification will be described. In the present modification, the configurations of the embodiment are modified in the manner described below. Descriptions of configurations, operations, and effects similar to those of the embodiment will be omitted. An inspection apparatus 10 according to the present modification differs from that of the present embodiment in that determination as to whether or not dilation processing is to be applied is performed for each pixel, in view of the concern that anomaly detection cannot be performed by dilation processing.

In the present modification, in the case where dilation processing is to be applied as the deformation processing, the image deformation unit 102 determines, for each pixel, whether or not to apply the dilation processing according to an amount of change between a pixel value of an image to which erosion processing has been applied after the dilation processing and a pixel value of an image not subjected to deformation processing, and in the case where erosion processing is to be applied as the deformation processing, the image deformation unit 102 determines, for each pixel, whether or not to apply the erosion processing according to an amount of change in the pixel value between the image to which the dilation processing is applied after the erosion processing and an image not subjected to deformation processing. At this time, the image deformation unit 102 does not apply deformation processing to a pixel at which the change amount is large, and applies deformation processing to a pixel at which the change amount is small.

In the case where, for example, dilation processing is to be applied to a transmission image, the image deformation unit 102 determines, for each pixel, whether or not to apply the dilation processing according to an amount of change between a pixel value between an image to which erosion processing has been applied after dilation processing and a pixel value of a transmission image not subjected to dilation processing. At this time, the image deformation unit 102 does not apply deformation processing to a pixel at which the change amount is large, and applies deformation processing to a pixel at which the change amount is small.

Also, in the case where erosion processing is to be applied to an inverted transmission image obtained by performing inversion processing on a transmission image, the image deformation unit 102 determines, for each pixel, whether or not to apply the erosion processing according to an amount of change between a pixel value of an image to which dilation processing has been applied after erosion processing and a pixel value of an inverted transmission image not subjected to dilation processing. At this time, the image deformation unit 102 does not apply erosion processing to a pixel at which the change amount is large, and applies erosion processing to a pixel at which the change amount is small.

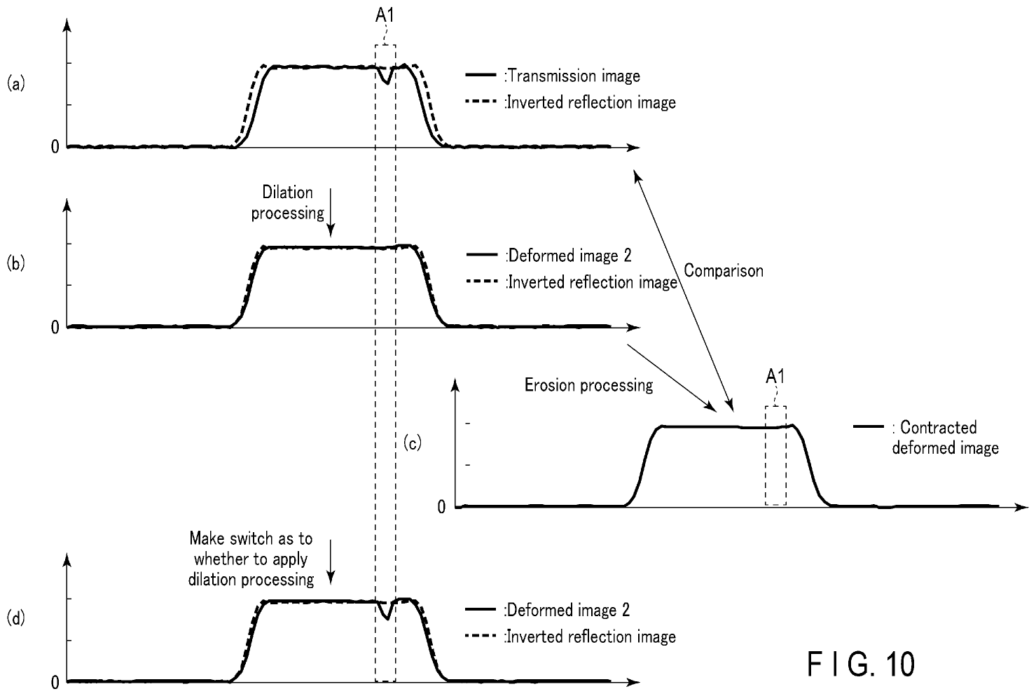

FIG. 10 is a diagram illustrating deformation processing according to the present modification. In FIG. 10, a difference value between each of a plurality of deformed images and an inverted reflection image according to the present modification is shown. The horizontal axis in FIG. 10 denotes a position on the same single pixel line as that in FIG. 7. The vertical axis in each of FIGS. 10(a)-(c) denotes an absolute value of the difference value. FIG. 10(a) shows pixel values of a deformed image 1 (0-pixel dilated image) and an inverted reflection image, and FIG. 10(b) shows pixel values of a deformed image 2 (1-pixel dilated image) and the inverted reflection image. FIG. 10(c) shows a pixel value of an image for comparison (hereinafter referred to as a “comparison image”) obtained by applying erosion processing to the deformed image 2 (1-pixel dilated image). FIG. 10(d) shows a pixel value of a deformed image 2 generated by making a switch, for each pixel, as to whether or not to apply dilation processing according to a result of comparison between a comparison image and a transmission image.

A pixel value of a deformed image 1 (0-pixel dilated image) in the case where small-size foreign matter is contained in a transmission image is shown in FIG. 10(a). In FIG. 10(a), the pixel value of the transmission image decreases in a region A1 due to the effect of the foreign matter. The size of the foreign matter is on the order of two pixels. If dilation processing is applied to such a transmission image, a pixel value that has decreased due to the presence of the foreign matter is replaced with a peripheral normal pixel value by the dilation processing, and the pixel value decrease due to the foreign matter is lost, as shown in FIG. 10(b). In this case, while the difference value generated at the pattern edge can be reduced, the foreign matter cannot be detected, and there is a concern that an anomaly cannot be detected by the dilation processing.

A pixel value of a comparison image obtained by applying a 1-pixel erosion process to the deformed image 2 is shown in FIG. 10(c). As shown in FIG. 10(c), if a 1-pixel erosion process is performed on a 1-pixel dilated image, pixel values of a transmission image to which dilation processing is not applied are restored in a relatively large region such as the pattern edge. However, in a fine region in which foreign matter may be present, if erosion processing is applied after dilation processing, the pixel value decrease caused by the foreign matter is not restored, and the pixel values of the transmission image to which dilation processing is not applied are not restored. Accordingly, a pixel at which an amount of change between the pixel value of the comparison image and the pixel value of the transmission image to which dilation processing is not applied is determined as a pixel at which foreign matter may possibly be present, and is excluded from the target to which dilation processing is to be applied. It is to be noted that a 0-pixel dilated image may be used, instead of the transmission image, for comparison with the comparison image.

A pixel value of a deformed image 2 obtained by applying dilation processing to a pixel with a change amount equal to or smaller than a predetermined value and not applying dilation processing to a pixel with a change amount greater than the predetermined value, and a pixel value of the inverted reflection image are shown in FIG. 10(d). By making a switch, for each pixel, as to whether or not to apply dilation processing, dilation processing is not applied to a pixel at which foreign matter may possibly be present, and thereby it is possible to suppress occurrence of a difference value resulting from a position gap at the pattern edge, while retaining the pixel value change due to the presence of the foreign matter, as shown in FIG. 10(d).

(Second Modification)

A second modification will be described. In the present modification, the configurations of the embodiment are modified in the manner described below. Descriptions of configurations, operations, and effects similar to those of the embodiment will be omitted. An inspection apparatus 20 according to the present modification differs from the inspection apparatus 10 in that the image input to the image deformation unit is an image 2 and that the processing of the difference generation unit is varied.

<Description of Apparatus>

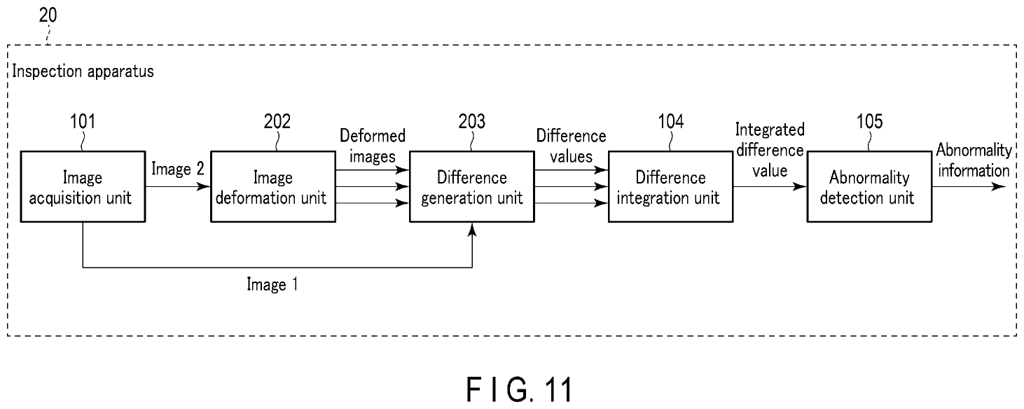

FIG. 11 is a conceptual diagram showing a configuration example of the inspection apparatus 20 according to the present modification. The inspection apparatus 20 includes an image acquisition unit 101, an image deformation unit 202, a difference generation unit 203, a difference integration unit 104, and an anomaly detection unit 105. Since configurations of the image acquisition unit 101, the difference integration unit 104, and the anomaly detection unit 105 are similar to those of the inspection apparatus 10, descriptions thereof will be omitted.

The image deformation unit 202 generates a plurality of deformed images by performing deformation processing on the image 2 output from the image acquisition unit 101. Thereafter, the image deformation unit 102 outputs the generated deformed images to the difference generation unit 103. That is, the inspection apparatus 20 differs from the inspection apparatus 10 in that deformation processing is applied not to the image 1 but to the image 2.

The difference generation unit 203 calculates, for each pixel, a difference value between the image 1 output from the image acquisition unit 101 and each of the deformed images output from the image deformation unit 102. The difference generation unit 203 outputs the obtained difference values to the difference integration unit 104.

<Description of Operation>

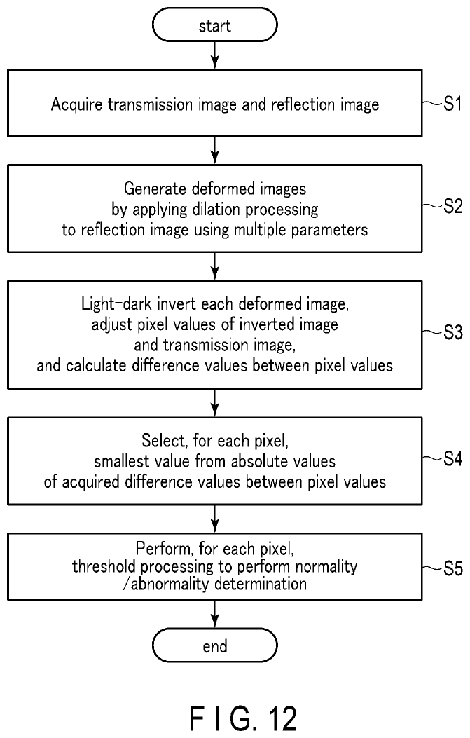

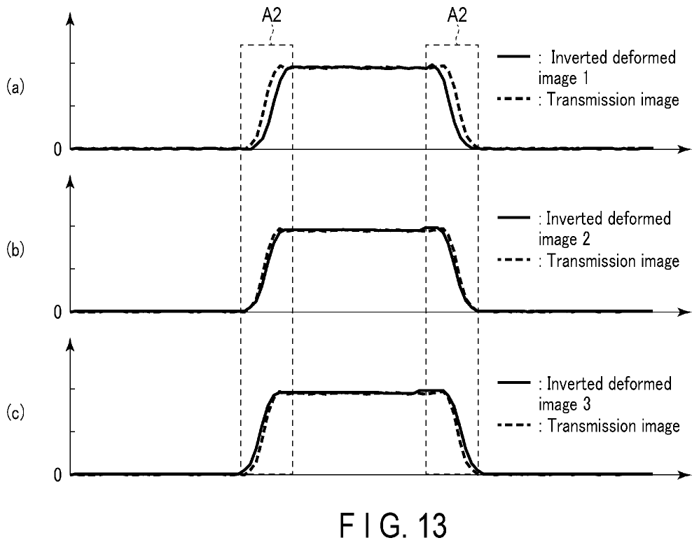

Next, an operation of processing executed by the inspection apparatus 20 will be described. FIG. 12 is a flowchart showing an example of procedures for anomaly detection processing executed by the inspection apparatus Processing of detecting foreign matter adhering to a mask using a transmission image and a reflection image will be described as an example of anomaly detection processing, similarly to the inspection apparatus 10 according to the embodiment. A case will be described where an image 1 is a transmission image and an image 2 is a reflection image, similarly to the inspection apparatus 10 according to the embodiment. It is to be noted that the procedures in the processing to be described below are given merely as an example, and may be suitably varied wherever possible. In the procedures to be described below, omission, substitution, and addition of one or more steps may be performed according to the embodiment.

(Step S1)

At step S1, the image acquisition unit 101 acquires a transmission image and a reflection image, similarly to the embodiment. After acquiring the transmission image and the reflection image, the image acquisition unit 101 outputs the reflection image to the image deformation unit 102, and outputs the transmission image to the difference generation unit 103.

(Step S2)

At step S2, the image deformation unit 202 applies deformation processing to the reflection image output from the image acquisition unit 101. In the present embodiment, too, dilation processing is used as the deformation processing. The image deformation unit 202 applies three types of different dilation processes, namely, a 0-pixel dilation process, a 1-pixel dilation process, and a 2-pixel dilation process, to the reflection image, and generates three types of dilation images, namely, a 0-pixel dilated image, a 1-pixel dilated image, and a 2-pixel dilated image as deformed images. The 0-pixel dilated image is the same as the original reflection image. The 1-pixel dilated image is an image in which the light portion of the original reflection image is dilated by one pixel by the one-pixel dilation processing. The 2-pixel dilated image is an image in which the light portion of the original reflection image is dilated by two pixels by the two-pixel dilation processing. The image deformation unit 202 outputs the generated three types of deformed images to the difference generation unit 203.

Differences between the processing by the image deformation unit 102 of the inspection apparatus 10 according to the embodiment and the processing by the image deformation unit 202 of the inspection apparatus 20 according to the present modification will be described with reference to FIG. 13. FIG. 13 is a diagram showing a pixel value of each of a plurality of deformed images and a pixel value of a transmission image. In FIG. 13, a pixel value of each deformed image in a light-dark inverted state is shown. The pixel values shown in FIG. 13 are of pixels on a single pixel line at the center of each image. The horizontal axis in FIG. 13 denotes a position on the single pixel line. The vertical axis in FIG. 13 denotes a pixel value. FIG. 13(a) shows pixel values of the deformed image 1 (0-pixel dilated image) and the transmission image, FIG. 13(b) shows pixel values of the deformed image 2 (1-pixel dilated image) and the transmission image, and FIG. 13(c) shows pixel values of the deformed image 3 (2-pixel dilated image) and the transmission image. In FIG. 13, the solid lines represent the deformed images, and the dashed lines represent the transmission image.

As shown in FIGS. 5 to 7, in the inspection apparatus 10 according to the present embodiment, an example has been described in which deformation is applied to the transmission image by means of dilation processing. Accordingly, in the above-described deformation processing by the inspection apparatus 10, processing of making the transmission image close to the reflection image by increasing the area of the pattern positioned at the center of the transmission image is performed. On the other hand, the inspection apparatus 20 according to the present modification applies deformation to the reflection image by means of dilation processing, as shown in FIG. 13. In this case, processing of making the reflection image close to the transmission image by decreasing the area of the pattern of the dark portion positioned at the center of the reflection image by means of dilation processing is performed. Accordingly, the position of the pattern edge in the peripheral region A2 of the pattern edge differs between the inspection apparatus 10 and the inspection apparatus 20.

(Step S3)

At step S3, the difference generation unit 203 calculates a difference value between a pixel value of the transmission image output from the image acquisition unit 101 and a pixel value of each of the deformed images output from the image deformation unit 202. Since the three types of dilation images are output by the image deformation unit 202, the difference generation unit 203 calculates, for each pixel, three difference values, namely, a difference value between the 0-pixel dilated image and the transmission image, a difference value between the 1-pixel dilated image and the transmission image, and a difference value between the 2-pixel dilated image and the transmission image. The difference generation unit 203 outputs the three calculated difference values to the difference integration unit 104.

At this time, the difference generation unit 203 generates three inverted deformed images by executing the above-described inversion processing of performing light-dark inversion on each of the deformed images, executes correction processing on each of the inverted deformed images to make the ranges of pixel values (pixel value ranges) of each of the inverted deformed images and the transmission image match, and calculates a difference value using a pixel value of each of the corrected inverted deformed images and a pixel value of the transmission image. The correction processing of the present modification can be executed by using, for example, the formula obtained by replacing R_{L}, R_{D}, T_{L}, and T_{D} in the formula (1) with a representative pixel value of a light portion of the inverted deformed image, a representative pixel value of a dark portion of the inverted deformed image, a representative pixel value of a light portion of the transmission image, and a representative pixel value of a dark portion of the transmission image, respectively.

A case has been described, as an example, where deformed images of a reflection image are light-dark inverted through inversion processing, thereby correcting pixel values of each of the deformed images of the reflection image in accordance with those of the transmission image; however, such processing may be performed on a transmission image. For example, a transmission image may be light-dark inverted by applying inversion processing on a transmission image. Moreover, a pixel value of a transmission image may be corrected in accordance with that of a deformed image.

Furthermore, a reflection image may be light-dark inverted in advance, and then erosion processing may be performed on the generated image. Thereby, an image similar to the image obtained by light-dark inverting the deformed images after dilation processing can be generated.

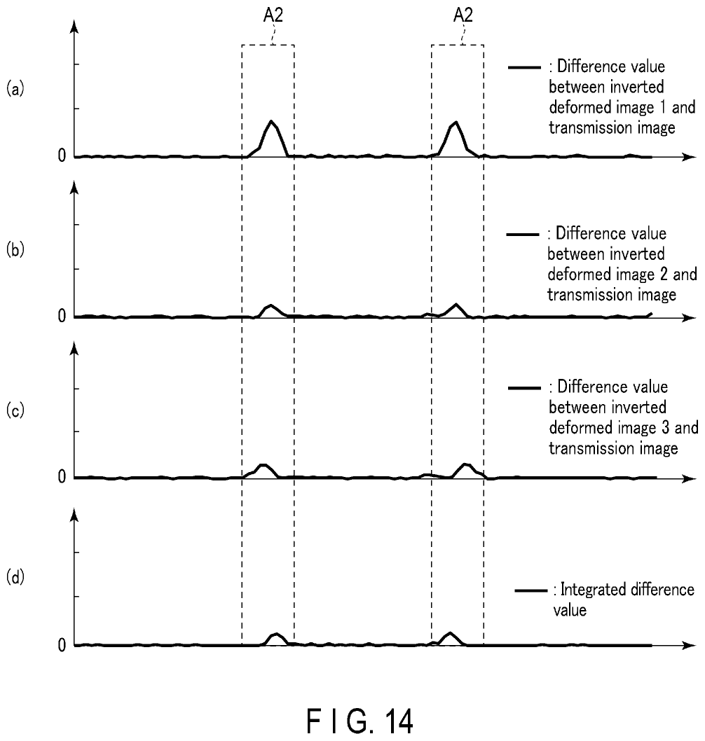

FIG. 14 is a diagram illustrating example processing of integrating a plurality of difference values. The horizontal axis in FIG. 14 denotes a position on the same single pixel line as that in FIG. 13. The vertical axis in each of FIGS. 14(a)-14(c) denotes an absolute value of the difference value. FIG. 14(a) denotes an absolute value of a difference value between the deformed image 1 (0-pixel dilated image) and the transmission image, FIG. 14(b) denotes an absolute value of a difference value between the deformed image 2 (1-pixel dilated image) and the transmission image, and FIG. 14(c) denotes an absolute value of a difference value between the deformed image 3 (2-pixel dilated image) and the transmission image.

(Step S4)

At step S4, the difference integration unit 104 calculates an integrated difference value by integrating a plurality of difference values output from the difference generation unit 203. Since a method of integrating difference values by the difference integration unit 104 is similar to that of the inspection apparatus 10 of the embodiment, a description thereof will be omitted. The difference integration unit 104 outputs the calculated integrated difference value to the anomaly detection unit 105.

FIG. 14(d) is a diagram showing an integrated difference value. In FIG. 14(d), the vertical axis denotes an integrated difference value. According to the inspection apparatus 20 of the present modification, a difference value in the peripheral region A2 of the pattern edge can be kept small, as shown in FIG. 14(d), similarly to the inspection apparatus 10 shown in FIGS. 7 and 8, and therefore effects similar to those of the inspection apparatus 10 can be obtained. On the other hand, since the position at which the difference value derived from the pattern edge occurs is located inward in FIGS. 13 and 14, compared to FIGS. 7 and 8, it can be seen that the position at which a difference value occurs varies with the difference in the image to be deformed.

(Step S5)

At step S5, the anomaly detection unit 105 performs threshold processing on the integrated difference value output from the difference integration unit 104, and performs determination as to whether an inspection target is normal or anomalous. Since a method of determination by the anomaly detection unit 105 is similar to that of the inspection apparatus 10 of the embodiment, a description thereof will be omitted.

According to the inspection apparatus 20 of the present modification, an integrated difference value in the periphery of the pattern edge can be kept small, as shown in FIGS. 14(d), and effects similar to those of the inspection apparatus 10 can be obtained.

(Third Modification)

A third modification will be described. In the present modification, the configurations of the embodiment are modified in the manner described below. Descriptions of configurations, operations, and effects similar to those of the embodiment will be omitted. In an inspection apparatus of the present modification, by combining integrated difference values obtained from both the inspection apparatus 10 of the embodiment and the inspection apparatus 20 of the second modification, a difference value in the periphery of the pattern edge can be made even smaller.

<Description of Apparatus>

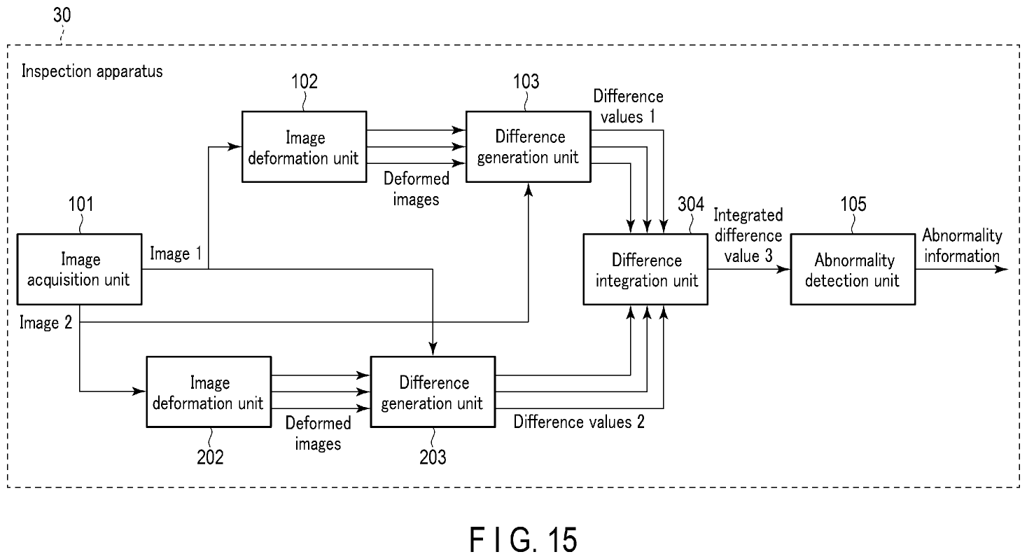

FIG. 15 is a conceptual diagram showing a configuration example of the inspection apparatus 30 according to the present modification. The inspection apparatus 30 includes an image acquisition unit 101, an image deformation unit 102, an image deformation unit 202, a difference generation unit 103, a difference generation unit 203, a difference integration unit 304, and an anomaly detection unit 105. Since configurations of the image acquisition unit 101, the image deformation unit 102, and the image deformation unit 202 are similar to those of the inspection apparatus 10 or the inspection apparatus 20, descriptions thereof will be omitted.

The difference generation unit 103 calculates a plurality of difference values 1 between a pixel value of each deformed image of an image 1 and a pixel value of an image 2. The difference value 1 corresponds to a first difference value. Since processing of calculating the difference value 1 is similar to that of the inspection apparatus 10, a description thereof will be omitted. The difference generation unit 103 outputs the calculated difference value 1 to the difference integration unit 304.

The difference generation unit 203 calculates a plurality of difference values 2 between a pixel value of each deformed image of the image 2 and a pixel value of the image 1. The difference value 2 corresponds to a second difference value. Since processing of calculating the difference values is similar to that of the inspection apparatus 20, a description thereof will be omitted. The difference generation unit 203 outputs the calculated difference value 2 to the difference integration unit 304.

The difference integration unit 304 calculates an integrated difference value 1 by integrating a plurality of difference values 1 output from the difference generation unit 103, and calculates an integrated difference value 2 by integrating a plurality of difference values 2 output from the difference generation unit 203. The integrated difference value 1 corresponds to a first integrated difference value 1, and the integrated difference value 2 corresponds to a second integrated difference value. Since processing of integrating the difference values is similar to those of the inspection apparatuses 10 and 20, a description thereof will be omitted. The difference integration unit 304 calculates an integrated difference value 3 by integrating the integrated difference value 1 and the integrated difference value 2. The integrated difference value 3 corresponds to a third integrated difference value. For the calculation of the integrated difference value 3, a method similar to the method of calculating the integrated difference value 1 and the integrated difference value 2 can be used. For example, the integrated difference value 3 is calculated by selecting either the integrated difference value 1 or the integrated difference value 2, whichever is smaller, as the integrated difference value 3. The difference integration unit 304 outputs the calculated integrated difference value 3 to the anomaly detection unit 105.

The anomaly detection unit 105 performs threshold processing on the integrated difference value 3 output from the difference integration unit 304, and performs determination as to whether an inspection target is normal or anomalous. Since a method of the determination by the anomaly detection unit 105 is similar to that of the inspection apparatus 10 or 20 of the embodiment, a description thereof will be omitted.

<Description of Operation>

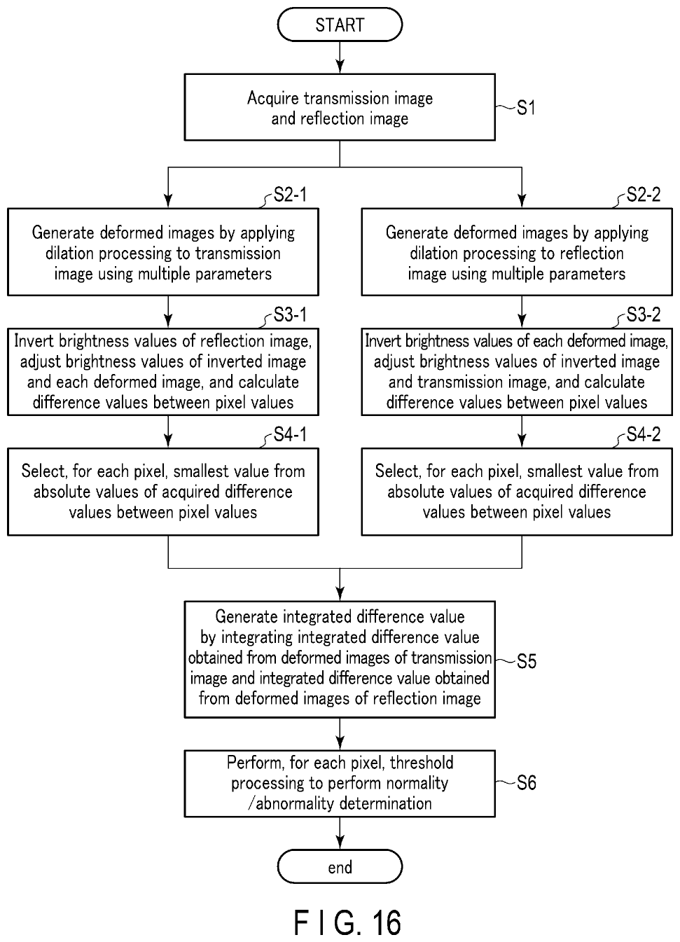

Next, an operation of processing executed by the inspection apparatus 30 will be described. FIG. 16 is a flowchart showing an example of procedures for anomaly detection processing executed by the inspection apparatus 30. Processing of detecting foreign matter adhering to a mask using a transmission image and a reflection image will be described as an example of the anomaly detection processing, similarly to the inspection apparatus 10 according to the embodiment and the inspection apparatus 20 according to the second modification. A case will be described where an image 1 is a transmission image and an image 2 is a reflection image, similarly to the inspection apparatus 10 according to the embodiment and the inspection apparatus 20 according to the second modification. It is to be noted that the procedures in the processing to be described below are given merely as an example, and may be suitably varied wherever possible. In the procedures to be described below, omission, substitution, and addition of one or more steps may be performed according to the embodiment.

(Step S1)

At step S1, the image acquisition unit 101 acquires a transmission image and a reflection image. After acquiring the transmission image and the reflection image, the image acquisition unit 101 outputs the transmission image to both of the image deformation unit 102 and the difference generation unit 203, and outputs the reflection image to both of the image deformation unit 202 and the difference generation unit 103.

(Step S2-1)

At step S2-1, the image deformation unit 102 applies three types of different dilation processes, namely, a 0-pixel dilation process, a 1-pixel dilation process, and a 2-pixel dilation process, to the transmission image output from the image acquisition unit 101, and generates three types of dilation images, namely, a 0-pixel dilated image, a 1-pixel dilated image, and a 2-pixel dilated image as deformed images, similarly to the inspection apparatus 10 of the embodiment. The image deformation unit 102 outputs the generated three types of deformed images to the difference generation unit 103.

(Step S3-1)

At step S3-1, the difference generation unit 103 calculates, for each pixel, three difference values, namely, a difference value between the 0-pixel dilated image and the reflection image, a difference value between the 1-pixel dilated image and the reflection image, and a difference value between the 2-pixel dilated image and the reflection image, as a difference value between the pixel value of the reflection image output from the image acquisition unit 101 and the pixel value of each deformed image output from the image deformation unit 102, similarly to the inspection apparatus 10 according to the embodiment. At this time, the difference generation unit 103 generates an inverted reflection image by executing inversion processing on the reflection image, executes the above-described correction processing on the inverted reflection image to make the ranges of pixel values (pixel value ranges) of each of the deformed images and the inverted reflection image match, and then calculates difference values using a pixel value of the corrected inverted reflection image and a pixel value of each of the deformed images. The difference generation unit 203 outputs the difference value 1 including the three calculated difference values to the difference integration unit 304.

(Step S2-2)

At step S2-2, the image deformation unit 202 applies three types of different dilation processes, namely, a 0-pixel dilation process, a 1-pixel dilation process, and a 2-pixel dilation process, to the reflection image output from the image acquisition unit 101, and generates three types of dilation images, namely, a 0-pixel dilated image, a 1-pixel dilated image, and a 2-pixel dilated image as deformed images, similarly to the inspection apparatus 20 of the second modification. The image deformation unit 202 outputs the generated three types of deformed images to the difference generation unit 203.

(Step S3-2)

At step S3-2, the difference generation unit 203 calculates, for each pixel, three difference values, namely, a difference value between the 0-pixel dilated image and the transmission image, a difference value between the 1-pixel dilated image and the transmission image, and a difference value between the 2-pixel dilated image and the transmission image, as a difference value between the pixel value of the transmission image output from the image acquisition unit 101 and the pixel value of each deformed image output from the image deformation unit 202, similarly to the inspection apparatus 20 according to the second modification. At this time, the difference generation unit 203 generates three inverted deformed images by executing inversion processing on each of the deformed images, executes the above-described correction processing on each of the inverted deformed images to make the ranges of pixel values (pixel value ranges) of each of the inverted deformed images and the transmission image match, and calculates difference values using pixel values of each of the corrected inverted deformed images and the transmission image. The difference generation unit 203 outputs the difference value 2 including the three calculated difference values to the difference integration unit 304.

Through the above-described processing, the difference value 1 and the difference value 2 each including three difference values are output to the difference integration unit 304, and therefore six different difference values are output to the difference integration unit 304.

(Step S4-1)

At step S4-1, the difference integration unit 304 calculates an integrated difference value 1 by integrating three difference values included in the difference value 1 output from the difference generation unit 103, similarly to the inspection apparatus 10 of the embodiment.

(Step S4-2)

At step S4-2, the difference integration unit 304 calculates an integrated difference value 2 by integrating three difference values included in the difference value 2 output from the difference generation unit 203, similarly to the inspection apparatus 20 of the second modification.

The integration processing at steps S4-1 and S4-2 is executed by, for example, selecting a smallest value from among the absolute values of the difference values. At this time, the above-described edge specification processing of specifying a position of a pattern edge and making an integrated difference value at the specified position zero may be executed. In this case, since the position of a pixel determined to be located at the pattern edge differs between the case where the deformation processing is applied to a transmission image and the case where the deformation processing is applied to a reflection image, it is preferable that edge specification processing be applied to both the integrated difference value 1 and the integrated difference value 2.

(Step S5)

At step S5, the difference integration unit 304 calculates an integrated difference value 3 by further integrating the integrated difference value 1 and the integrated difference value 2 obtained by the processing at steps S4-1 and S4-2. In this integration processing, either the integrated difference value 1 or the integrated difference value 2, whichever is smaller, is selected.

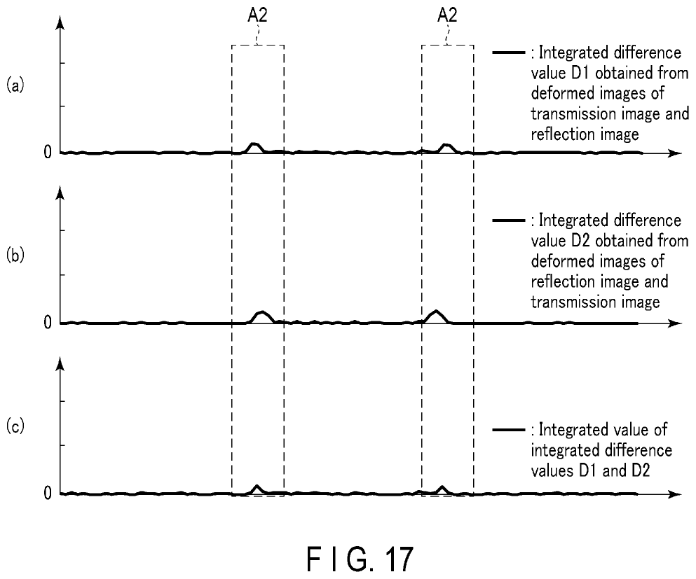

Effects of integration by the difference integration unit 304 will be described with reference to FIG. 17. FIG. 17 is a diagram showing an integrated difference value. The pixel values shown in FIG. 17 are of pixels on a single pixel line at the center of each image. The horizontal axis in FIG. 17 denotes a position on the single pixel line. In FIG. 17, the vertical axis denotes an integrated difference value. FIG. 17(a) shows an integrated difference value 1, FIG. 17(b) shows an integrated difference value 2, and FIG. 17(c) shows an integrated difference value 3.

As shown in FIG. 17, the positions of peaks of the integrated difference value 1 shown in FIG. 17(a) are displaced from those of the integrated difference value 2 shown in FIG. 17(b). Accordingly, it can be seen that, by further integrating the integrated difference value 1 and the integrated difference value 2, a difference value in the peripheral region A2 of the pattern edge is made even smaller, as shown by the integrated difference value 3 in FIG. 17(c). By thus applying deformation processing to two input images (a transmission image and a reflection image) and calculating difference values between each deformed image and a normal image to which deformation processing is not applied, and integrating the calculated difference values, a difference value in the peripheral region A2 of the pattern edge can be kept small, compared to the case where deformation processing is applied only to one of the two input images (i.e., the transmission image and the reflection image).

If the above-described edge specification processing is not performed, six difference values included in the difference value 1 and the integrated difference value 2 may be integrated at once, instead of steps S4-1, S4-2, and S5. Even in this case, results similar to the case where the integrated difference value 1 and the integrated difference value 2 are integrated can be obtained.

(Step S6)

At step S6, the anomaly detection unit 105 performs threshold processing on the integrated difference value 3 output from the difference integration unit 304, and performs determination as to whether an inspection target is normal or anomalous. Since a method of determination by the anomaly detection unit 105 is similar to that of the inspection apparatus 10 of the embodiment, a description thereof will be omitted.

In the present embodiment, an inspection method in which a difference value generated in the periphery of the pattern edge resulting from a pattern displacement is suppressed, thus allowing a large difference to occur only in a region in which an anomaly is present. As described in the first modification, a change of an image to which deformation processing is to be applied causes a change in the position at which a relatively large difference value occurs. In the inspection apparatus 30 according to the present modification, by further integrating the integrated difference value 1 obtained from the inspection apparatus of the embodiment and the integrated difference value 2 obtained from the inspection apparatus 20, an integrated difference value in the periphery of the pattern edge can be made even smaller, as shown in FIG. 17(c). By performing anomaly detection using the integrated difference value 3, it is possible to suppress erroneous detection at the time of detection of foreign matter, and to improve the detection precision of the foreign matter.

It is to be noted that the configuration of the inspection apparatus 30 may be suitably varied to achieve similar effects. For example, difference values between an image obtained by applying dilation processing to a transmission image generated by the image deformation unit 102 and an image obtained by applying dilation processing and inversion processing to the reflection image generated by the image deformation unit 202 in order may be calculated, and the calculated difference values may be integrated in a similar method.

(Fourth Modification)

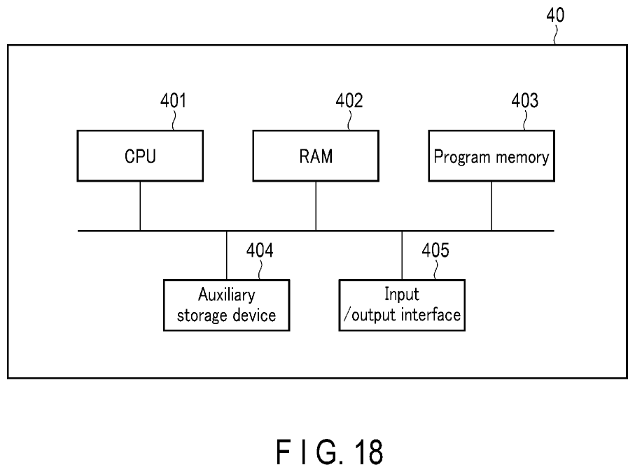

FIG. 18 is a block diagram illustrating a hardware configuration of an inspection apparatus 40 according to a fourth modification. The fourth modification is a specific example of the embodiment and the first to third modifications, in which the inspection apparatuses 10, 20, and 30 are realized by a computer.

The inspection apparatus 40 includes, as hardware, a central processing unit (CPU) 401, a random-access memory (RAM) 402, a program memory 403, an auxiliary storage device 404, and an input/output interface 405. The CPU 401 communicates with a RAM 402, a program memory 403, an auxiliary storage device 404, and an input/output interface 405 via a bus. That is, the inspection apparatus of the present embodiment is realized by a computer with such a hardware configuration.

The CPU 401 is an example of a general-purpose processor. The RAM 402 is used by the CPU 401 as a working memory. The RAM 402 includes a volatile memory such as a synchronous dynamic random access memory (SDRAM). The program memory 403 stores a data analysis program for realizing components corresponding to each embodiment. The data analysis program may be a program for causing a computer to realize the functions of, for example, the image acquisition unit 101, the image deformation units 102 and 202, the difference generation units 103 and 203, the difference integration units 104 and 304, and the anomaly detection unit 105. A part of the auxiliary storage device 404 or a read-only memory (ROM), or a combination thereof is used as the program memory 403. The auxiliary storage device 404 stores data in a non-transitory manner. The auxiliary storage device 404 includes a nonvolatile memory such as a hard disc drive (HDD) or a solid-state drive (SSD).

The input/output interface 405 is an interface for connecting to another device. The input/output interface 405 is used for, for example, connection with a keyboard, a mouse, a database, and a display.

The data analysis program stored in the program memory 403 includes a computer executable instruction. When executed by the CPU 401, which is processing circuitry, the data analysis program (computer executable instruction) causes the CPU 401 to execute predetermined processing. When executed by the CPU 401, the data analysis program causes the CPU 401 to execute a series of processing described with reference to FIG. 1, 11, or 15 with respect to each component. When executed by the CPU 401, the computer executable instruction included in the data analysis program causes the CPU 401 to execute predetermined processing. The data analysis method may include each of the steps corresponding to the functions of the image acquisition unit 101, the image deformation units 102 and 202, the difference generation units 103 and 203, the difference integration units 104 and 304, and the anomaly detection unit 105. The data analysis method may suitably include the steps shown in FIG. 4, 12 or 16.

The data analysis program may be provided to the inspection apparatus 40, which is a computer, in a state of being stored in a computer-readable storage medium. In this case, the inspection apparatus 40 may further include, for example, a drive (not illustrated) configured to read data from a storage medium, and to acquire a data analysis program from the storage medium. Examples of the storage medium that may be suitably used include a magnetic disc, an optical disc (CD-ROM, CD-R, DVD-ROM, DVD-R, etc.), a magnetooptical disc (e.g., MO), a semiconductor memory, etc. The storage medium may be referred to as a non-transitory computer readable storage medium. The data analysis program may be stored in a server on a communication network, in such a manner that the inspection apparatus 40 downloads the data analysis program from the server using the input/output interface 405.

The processing circuitry configured to execute the data analysis program is not limited to a general-purpose hardware processor such as the CPU 401, and a dedicated hardware processor such as an application-specific integrated circuit (ASIC) may be used. The term “processing circuitry” includes at least one general-purpose hardware processor, at least one dedicated hardware processor, or a combination of at least one general-purpose hardware processor and at least one dedicated hardware processor. In the example shown in FIG. 18, the CPU 401, the RAM 402, and the program memory 403 correspond to the processing circuitry.

(Other Modifications)

A case has been described where a transmission image and a reflection image are compared to detect foreign matter adhering to a mask, which is an inspection target; however, the configuration of the present application can be similarly applied to an apparatus configured to compare a reference image and an inspection image to detect a defect of a mask. In this case, either the reference image or the inspection image is used as the image 1, and the other one is used as the image 2. Deformed images obtained by applying deformation processing such as enlargement processing, reduction processing, parallel movement processing, and rotation processing to at least one of the reference image and the inspection image are generated.

For the deformation processing, any type of deformation processing may be used, according to the characteristics of the images 1 and 2. For example, if a transmission image and a reflection image are used as the images 1 and 2, as in the above-described embodiment, dilation processing or erosion processing is used as the deformation processing, since, in general, a transmission image and a reflection image are equal in optical magnification and are already aligned in position. If the optical magnifications of the images 1 and 2 are different, enlargement processing or reduction processing is used as the deformation processing. If the positions of the images 1 and 2 are displaced from one another, parallel movement processing is used as the deformation processing. If one of the images 1 and 2 is rotated, rotation processing is used as the deformation processing. The deformation processing may be processing in which the above-described multiple types of processing are combined.

In this manner, even if a position gap occurs between two images used for a comparison inspection resulting from the characteristics of the images or the method of their acquisition, it is possible to suppress occurrence of a difference due to the effect of the position gap, and to improve the precision of anomaly determination using the difference by generating a plurality of deformed images by applying a given type of deformation processing according to the characteristics of the comparison images, calculating a plurality of difference values (pixel value differences) using the deformed images, and integrating the calculated difference values.

Thus, according to one of the embodiments described above, it is possible to provide an inspection apparatus, an inspection method, and a program capable of detecting only anomalies such as defects and foreign matter, while permitting a pattern displacement between the images to be compared, using only simple image processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection apparatus comprising processing circuitry configured to:
acquire a first image and a second image for inspecting an inspection target;
generate a plurality of deformed images by applying a plurality of deformation processes to at least one of the first image or the second image;
calculate, for each pixel, a difference value between a pixel value of the first image and a pixel value of the second image, using the deformed images;
calculate a pixel-by-pixel integrated difference value by integrating a plurality of difference values calculated for the respective deformed images; and
detect an anomaly of the inspection target based on the pixel-by-pixel integrated difference value.

2. The inspection apparatus according to claim 1, wherein
the first image is a transmission image generated based on light that has transmitted through the inspection target,
the second image is a reflection image generated based on light that has reflected from the inspection target, and
the processing circuitry is configured to generate an inverted image by applying light-dark inversion processing to the transmission image or the reflection image, and calculate the difference value using a normal image and the inverted image, the normal image being the transmission image or the reflection image to which the inversion processing is not applied.

3. The inspection apparatus according to claim 2, wherein
each of the deformation processes is an dilation process or a erosion process.

4. The inspection apparatus according to claim 3, wherein
the processing circuitry is configured to:
if the dilation process is to be applied as the deformation process, determine, for each pixel, whether or not to apply the dilation process in accordance with an amount of change between a pixel value of an image to which the erosion process has been applied after the dilation process and a pixel value of an image not subjected to the deformation process; and
if the erosion process is to be applied as the deformation process, determine, for each pixel, whether or not to apply the erosion process in accordance with an amount of change between a pixel value of an image to which the dilation process has been applied after the erosion process and an image not subjected to the deformation process.

5. The inspection apparatus according to claim 4, wherein
the processing circuitry is configured to forgo application of the deformation process to a pixel at which the amount of change is large, and apply the deformation process to a pixel at which the amount of change is small.

6. The inspection apparatus according to claim 2, wherein
the processing circuitry is configured to subject the inverted image or the normal image to a pixel value correction so that a range of pixel values of the inverted image and a range of pixel values of the normal image match each other, and calculate the difference value using the image subjected to the pixel value correction.

7. The inspection apparatus according to claim 1, wherein
the processing circuitry is configured to select, as the pixel-by-pixel integrated difference value, a difference value whose absolute value is smallest from among the plurality of difference values.

8. The inspection apparatus according to claim 1, wherein
the processing circuitry is configured to set the pixel-by-pixel integrated difference value of a pixel, for which the calculated difference values have different signs, to zero.

9. The inspection apparatus according to claim 1, wherein
the processing circuitry is configured to:
calculate, if the generated deformed images include only deformed images of the first image, a difference between a pixel value of each deformed image and a pixel value of the second image as the difference value;
calculate, if the generated deformed images include only deformed images of the second image, a difference between a pixel value of each deformed image and a pixel value of the first image as the difference value; and
calculate, if the generated deformed images include one or more deformed images of the first image and one or more deformed images of the second image, a difference between the pixel value of each deformed image of the first image and the pixel value of each deformed image of the second image as the difference value.

10. The inspection apparatus according to claim 1, wherein
the processing circuitry is configured to:
calculate a difference between a pixel value of a deformed image of the first image and a pixel value of the second image as a first difference value, and calculate a difference between a pixel value of a deformed image of the second image and a pixel value of the first image as a second difference value; and
calculate a first integrated difference value by integrating a plurality of first difference values calculated for the respective deformed images, calculate a second integrated difference value by integrating a plurality of second difference values calculated for the respective deformed images, and calculate the pixel-by-pixel integrated difference value by integrating the first integrated difference value and the second integrated difference value.

11. An inspection method comprising:
acquiring a first image and a second image for inspecting an inspection target;
generating a plurality of deformed images by applying a plurality of deformation processes to at least one of the first image or the second image;
calculating, for each pixel, a difference value between a pixel value of the first image and a pixel value of the second image, using the deformed images;
calculating a pixel-by-pixel integrated difference value by integrating a plurality of difference values calculated for the respective deformed images; and
detecting an anomaly of the inspection target based on the pixel-by-pixel integrated difference value.

12. A non-transitory computer-readable storage medium storing a program for causing a computer to execute functions of:
acquiring a first image and a second image for inspecting an inspection target;
generating a plurality of deformed images by applying a plurality of deformation processes to at least one of the first image or the second image;
calculating, for each pixel, a difference value between a pixel value of the first image and a pixel value of the second image, using the deformed images;
calculating a pixel-by-pixel integrated difference value by integrating a plurality of difference values calculated for the respective deformed images; and
detecting an anomaly of the inspection target based on the pixel-by-pixel integrated difference value.
